(19) United States
(12) Patent Application Publication
(10) Pub. No.: US 2013/0253874 A1
(43) Pub. Date: Sep. 26, 2013

(54) METHODS OF CONSTRUCTING DATA ACQUISITION SYSTEMS WITH FOCUSING CONTROLLED SENSITIVITY

(71) Applicant: Michael S. Zhdanov, Holladay, UT (US)

(72) Inventor: Michael S. Zhdanov, Holladay, UT (US)

(73) Assignee: TECHNOIMAGING, LLC, Salt Lake City, UT (US)

(21) Appl. No.: 13/617,963

(22) Filed: Sep. 14, 2012

Related U.S. Application Data
(60) Provisional application No. 61/535,590, filed on Sep. 16, 2011.
(60) Provisional application No. 61/541,722, filed on Sep. 30, 2011.

(51) Int. Cl. G06F 17/00

(52) U.S. Cl. CPC G06F 17/00
USPC 702/104

(57) ABSTRACT

A method for constructing data acquisition systems with focusing controlled sensitivity, capable of resolving physical parameters of the targeted area of a medium under investigation. The sensors of a data acquisition system may measure different physical fields and signals, generated by natural or artificial sources, including seismic, electromagnetic, gravity and/or magnetic fields, and/or optical, radio, low and high frequency radiation signals. A sensitivity of the data acquisition system to the parameters of the examined medium may be calculated. A priori integrated sensitivity, having maximum values within desirable parts of the examined medium, may be selected. The parameters of the optimal transformation of the original data acquisition system into a new one with integrated sensitivity closely duplicating the preselected sensitivity may be determined. This optimal transformation may be applied to the sensors of the original data acquisition system to construct a new data acquisition system with focusing controlled sensitivity.

### CROSS-REFERENCE TO RELATED APPLICATIONS

This application claims the benefit of U.S. Provisional Application No. 61/535,590, filed Sep. 16, 2011, and the benefit of U.S. Provisional Application No. 61/541,722, filed Sep. 30, 2011, both of which are incorporated herein by reference in their entirety.

This application hereby incorporates the following publications by reference in their entirety: Zhdanov, M. S., 2002, Geophysical inverse theory and regularization problems: Elsevier; Zhdanov, M. S., 2009, Geophysical electromagnetic theory and methods: Elsevier. This application hereby incorporates U.S. Pat. No. 7,550,969 by Zhdanov in its entirety.

### BACKGROUND OF THE INVENTION

1. The Field of the Invention

The present disclosure relates in general to constructing data acquisition systems with focusing controlled sensitivity, capable of resolving physical parameters of the targeted area of the medium under investigation.

2. The Related Technology

Data acquisition systems formed by a set of sensors of signals of different physical nature are widely used in science, engineering, medical imaging, and energy and mineral resources exploration, and other technical, biological, and medical applications. These data acquisition systems are typically based on measurements of the different physical fields and signals, including but not limited to seismic, electromagnetic, gravity and/or magnetic fields, and/or optical, radio, low and high frequency radiation signals.

The typical data acquisition systems have a specific sensitivity determined by the physical nature of the measured data, geometrical design of a system, and configuration and type of a source of the recorded data. This sensitivity is usually limited to a specific “visible” part of the examined medium, located relatively close to the sensors.

It was demonstrated by Zhdanov, 2002, that the size of this “visible” part of the examined medium can be determined based on the analysis of the integrated sensitivity of a survey, which allows the observer to evaluate a cumulative response of the observed data to the parameters of the examined medium for a given data acquisition system. It was shown by Zhdanov, 2002, that, in a general case, the integrated sensitivity depends on many parameters, including design of data acquisition system, the physical nature of the measured data, and configuration and type of a source of the observed data. Any given data acquisition system may have limited sensitivity to some parts of potential interest within the examined medium. Therefore, a need exists in developing a method of constructing data acquisition systems with enhanced controlled sensitivity, focused in the zones of interest within a medium under investigation.

### BRIEF SUMMARY

Embodiments disclosed herein relate to methods, systems, and computer readable media for constructing data acquisition systems with focusing controlled sensitivity having maximum values in zones of interest of a medium under investigation. One or more sensors of a corresponding physical field and/or signal generated by natural or artificial sources are placed at some proximity of an examined medium.

At least one component of the corresponding physical field and/or signal is measured by the at least one sensor. The measured data is then recorded in a recording device.

The sensitivity of the data acquisition system as a ratio of a perturbation of the measured data to the perturbation of parameters of the examined medium is determined. An a priori integrated sensitivity that has maximum values in the zones of interest is selected.

Parameters of an optimal transformation for transforming the data acquisition system into a new data acquisition system are determined. The new data acquisition system has a controlled integrated sensitivity that closely duplicates the a priori sensitivity. This is accomplished by solving a minimization problem for a least square difference between the sensitivities.

The optimal transformation is applied to the sensors of the original data acquisition system in order to construct a new data acquisition system with focusing controlled sensitivity.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1A illustrates a data acquisition system according to the embodiments disclosed herein;

FIG. 1B illustrates an embodiment of the processor of FIG. 1A;

FIG. 2 illustrates a method for constructing data acquisition systems with focusing controlled sensitivity, capable of resolving physical parameters of the targeted area of the medium under investigation, according to the embodiments disclosed herein;

FIG. 3 illustrates a model, where the data acquisition system is formed by a towed streamer electromagnetic system formed by a horizontal electric dipole transmitter and horizontal electric dipole receivers according to the embodiments disclosed herein;

FIG. 4 illustrates a method for constructing data acquisition systems with focusing controlled sensitivity, capable of resolving physical parameters of the targeted area of the medium under investigation for the model shown in FIG. 3;

FIG. 5 illustrates an alternative embodiment of the data acquisition system according to the embodiments disclosed herein;

FIG. 6 illustrates a further alternative embodiment of the data acquisition system according to embodiments disclosed herein.

### DETAILED DESCRIPTION

At least one embodiment of a method disclosed herein, for example, can be applied for constructing the optimal geophysical data acquisition systems for subsurface imaging of geological structures for mineral, hydrocarbons, geothermal and groundwater exploration, unexploded ordinance detection, underground structures and tunnel detection, anti-submarine warfare, and environmental monitoring, using seismic, electromagnetic, gravity and/or magnetic data.

Another embodiment of the present invention can be used for constructing the optimal data acquisition system for medical imaging, using x-rays, MRI, ultrasound, electromagnetic radiation, and other imaging techniques.

Another embodiment of the present invention is based on “focusing” the sensitivity of the data acquisition system on a specific area of the examined medium, where a potential target (e.g., mineral deposit in a case of geologic exploration, or anomalous tissue in a case of medical imaging) may be located. In one embodiment, “focusing” the sensitivity can be achieved by selecting some a priori preselected sensitivity, having maximum values within the targeted parts of the examined medium, and adjusting the parameters of the data acquisition system in order to construct a desired system with the integrated sensitivity approximating the a priori preselected sensitivity the best. The desired data acquisition system with the pre-selected controlled sensitivity can be constructed physically, or this reconstruction may be done numerically using computer transformation.

The transformation of the original data acquisition system into a new one with the controlled sensitivity is done by a combination of the sensors with the parameters, selected based on the a priori sensitivity. The selection of these parameters is based on the solution of the minimization problem describing the approximation of the pre-selected a priori sensitivity by the corresponding sensitivity of new data acquisition system, produced as a result of this transformation.

At least one embodiment of this method can be used in geophysical exploration for mineral resources. Another embodiment of this method can be used for hydrocarbon exploration. Another embodiment of this method can be used in well-logging and well geosteering. Another embodiment of this method can be used for security screening and inspection. Another embodiment of this method can be used for improvise explosive devices (IED) detection. Another embodiment of this method can be used for unexploded ordinance detection. Another embodiment of this method can be used in the underground structures and tunnel detection. Another embodiment of this method can be used for anti-submarine warfare. Another embodiment of this method can be used for environmental monitoring. Another embodiment of this method can be used in radio location system. Another embodiment of this method can be used in constructing high resolution optical systems. Another embodiment of this method can be used in constructing optical and/or radio telescopes. Another embodiment of this method can be used in acoustic systems. Yet another embodiment of this invention can be used in medical imaging.

More specifically, a data acquisition system can be used to locate and characterize an object within an examined medium through a method that includes placing a sensor of the corresponding physical fields and/or signals, generated by the natural or artificial (controlled) sources, at some proximity of the examined medium; measuring at least one component of the corresponding physical fields and/or signals with the at least one sensor and recording the observed data by the corresponding recording device; determining the sensitivity of the data acquisition system as a ratio of the perturbation of the observed data to the corresponding perturbation of the parameters of the examined medium; selecting a priori sensitivity having maximum values within the desirable parts of the examined medium; determining the parameters of the optimal transformation of the original data acquisition system into a new one with the (controlled) integrated sensitivity closely duplicated the preselected sensitivity by solving a minimization problem for a least square difference between the preselected and controlled sensitivities; applying this optimal transformation to the sensors of the original data acquisition system in order to constructing a new data acquisition system with focusing controlled sensitivity.

In one embodiment, the data acquisition system may comprise of a portal that includes at least one sensor of at least one physical field and/or signal, and may be used for security screening a body and/or attached object, or a container, or another object which is moving through the portal. The portal is configured to accommodate and pass there through the body and/or an attached object, or a container, or another object. In the present embodiment, the sensors may record at least one component of the corresponding physical fields and/or signals, generated as a response from a body and/or attached object, or a container, or another object which is moving through the portal. The data acquisition system is characterized by the integrated sensitivity to the parameters of the object moving through the portal, which is evaluated as a ratio of the perturbation of the observed data to the corresponding perturbation of the parameters of the examined object. In a general case, the sensitivity of the data acquisition system will be distributed both inside and outside of the portal, decreasing away from the sensors. In practical applications, the goal is to have the maximum sensitivity within the portal, and practically no sensitivity outside the portal. According to one embodiment of the present invention, the a priori sensitivity is selected having maximum values within the portal and reduced sensitivity outside the portal. The parameters of the optimal transformation of the original data acquisition system into a new one with the (controlled) integrated sensitivity, having maximum within the portal, are determined by solving a minimization problem for a least square difference between the preselected and controlled sensitivities.

In yet another embodiment of the present invention, the data acquisition system may comprise of at least one sensor located in at least one post, standing on the floor or on the ground, or in the holder located just under the floor or under the ground surface. This data acquisition system may be used to create a “virtual portal” for security screening a body and/or attached object, or a container, or another object which is moving through the “virtual portal.” For example, the “virtual portal,” in some embodiments, may be unseen by the user, unlike most security applications, such as x-ray scanners, backscatter x-ray scanners, and other more visible security measures. The data acquisition system is configured to accommodate and pass there through the body and/or an attached object, or a container, or another object. In the present embodiment, the sensors may record at least one component of the corresponding physical fields and/or signals, generated as a response from a body and/or attached object, or a container, or another object which is moving through the portal. The data acquisition system is characterized by the integrated sensitivity to the parameters of the object moving through the “virtual portal,” which is evaluated as a ratio of the least square norm of the perturbation of the observed data to the corresponding perturbation of the parameters of the examined object. In a general case, the sensitivity of the data acquisition system will be decreasing away from the sensors. In practical applications, the goal is to have the maximum sensitivity within the “virtual portal,” and a minimum sensitivity outside the “virtual portal.” According to one embodiment of the present invention, the a priori sensitivity is selected having maximum values within the “virtual portal” and minimum sensitivity outside the “virtual portal.” The parameters of the optimal transformation of the original data acquisition system into a new one with the (controlled) integrated sensitivity, having maximum within the “virtual portal,” are determined by solving a minimization problem for a least square difference between the preselected and controlled sensitivities.

At least one embodiment of a method disclosed herein, for example, may be applied for security screening and inspection of passengers of buses, trains, underground trains, airlines, and ships, as well as of visitors to offices and secured buildings, the participants of the spot events and other massive gatherings events (e.g., in amazing parks, awards ceremonies, conferences, meetings, etc.). In another embodiment of the present invention, the “virtual portal” can be used for conceived screening of the participants of the massive gatherings events, or visitors in the secured buildings. In yet another embodiment of a method disclosed herein, the physical portals or virtual portals may be used for screening the containers in the railway stations, airports, and seaports.

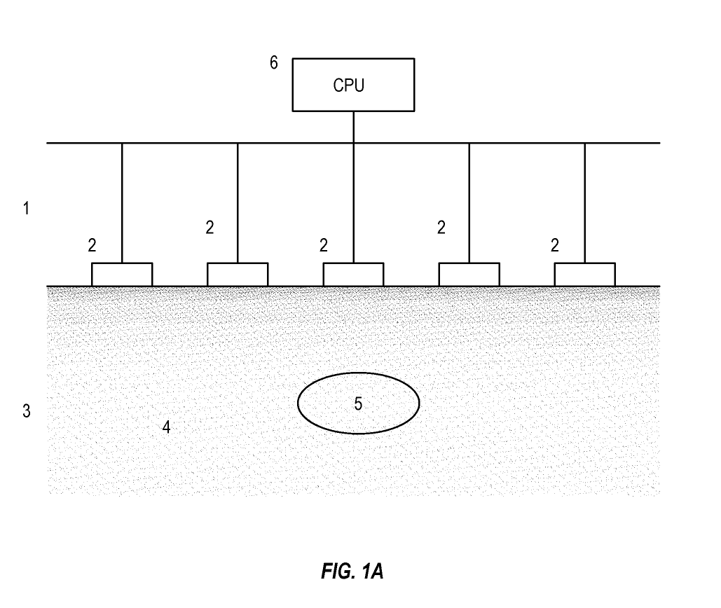

Attention is now given to FIG. 1A, illustrates an embodiment of a data acquisition system 1 that may be used to practice the embodiment disclosed herein. The data acquisition system 1 may include one or more sensors of different physical fields and/or signals 2 that are located at some proximity of an examined medium 3. In one embodiment, the sensors 2 may be arranged as an array on the surface or within the examined medium 3. It will be appreciated that the sensors 2 may be arranged in any reasonable manner. In some embodiments, the sensors 2 may be seismic, electric, magnetic, gravity, acoustic, and/or temperature field sensors or any combination thereof. In other embodiments, the sensor 2 may be optical, electromagnetic, elastic, and/or radio wave signal sensors or any combination thereof. It will be appreciated that the sensors 2 may be any reasonable type of sensor or combination of sensors as circumstances warrant.

In one embodiment, the sensors 2 may record at least one component of corresponding physical fields and/or signals, generated as a response from the examined medium 3 to the natural or artificial (controlled) sources. The data acquisition system 1 is characterized by an integrated sensitivity to the parameters of the medium 3, which is evaluated as a ratio of the least square norm of perturbation of observed data to a corresponding perturbation of the parameters of the examined medium 3. In a general case, the sensitivity of the data acquisition system 1 decreases with distance from the sensors 2 as schematically illustrated by gradient shading 4 in FIG. 1A, where the dark black color corresponds to the high sensitivity, and the light gray color corresponds to the low sensitivity.

In practical applications, a targeted area of the examined medium 3 may be located, for example, within a domain 5 outlined by a solid oval line in FIG. 1A. According to one embodiment of the present invention, a priori sensitivity is selected having maximum values within the targeted area 5 of the examined medium 3. The parameters of an optimal transformation of the original data acquisition system into a new one with the (controlled) integrated sensitivity, having a maximum within the same targeted area 4 shown in FIG. 1A, are determined by solving a minimization problem for a least square difference between the preselected and controlled sensitivities as will be explained in more detail to follow.

A processor 6, which may include, for example, a central processing unit, may operate the data acquisition system. FIG. 1B illustrates an embodiment of the processor 6, which in this embodiment may be a computing system that is able to perform various operations for constructing new data acquisition systems with focusing controlled sensitivity in accordance with the principles of the embodiments disclosed herein. As shown, the processor 6 receives measured data 110 that corresponds to at least one component of the physical fields and/or signals that have been generated by the natural or artificial (sources). As mentioned previously, the physical fields and/or signals may correspond to seismic, electric, magnetic, gravity, acoustic, and/or temperature field data, although other types of physical fields and/or signals may also be measured. The measured data 110 may be recorded in a memory or other recording device 70 of the processor 6.

As illustrated in FIG. 1B, the processor 6 includes a sensitivity module 20. The sensitivity module 30 may obtain and/or compute a sensitivity 25a, 25b, 25c of the data acquisition system 1. In one embodiment, the sensitivity module 20 determines the sensitivity of the data acquisition system as a ratio of the perturbation of the measured data to a corresponding perturbation of parameters of the examined medium 3.

The processor 6 may also include an a priori integrated sensitivity module 30. The a priori integrated sensitivity module 30 is operable to select a desired a priori integrated sensitivity 35 having maximum values within the desirable parts of the examined medium 3.

The processor 6 may include a determination module 40. The determination module 40 may be operable to determine parameters of an optimal transformation 45 of the data acquisition system 1 into a new data acquisition system that has a controlled integrated sensitivity that closely duplicates the preselected a priori integrated sensitivity. This may be accomplished in one embodiment by solving a minimization problem for a least square difference between the computed integrated sensitivity 25 and the selected a priori integrated sensitivity 35.

The processor 6 may further include a generation module 50 that may generate or construct a new data acquisition system 60. The generation module 50 may apply the optimal transformation 45 to the sensors 2 to construct the new data acquisition system 60 that has a focusing controlled sensitivity.

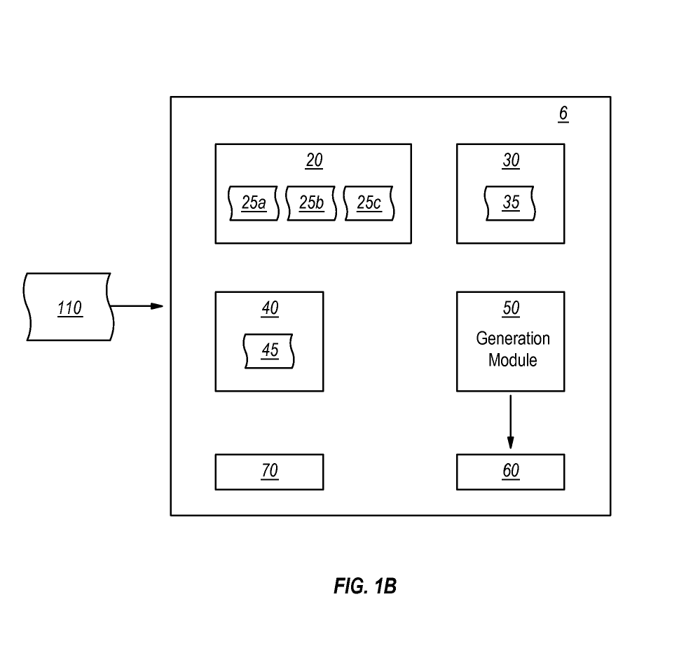

An embodiment of a method 200 for constructing data acquisition systems with focusing controlled sensitivity is schematically shown in FIG. 2. In the illustrated embodiment, the method 200, and other methods and processes described herein, set forth various functional blocks or actions that may be described as processing steps, functional operations, events and/or acts, etc., which may be performed by hardware, software, and/or firmware. The method 200 may be practiced by the data acquisition system described in relation to FIGS. 1A and 1B, although this is not required.

The method 200 includes an act 210 of placing at least one sensor at the proximity of an examined medium. The sensors may then measure at least one component of a corresponding physical field and/or signal and may record the measured or observed data. For example, in one embodiment, the observed or measured data 10 may be formed by the physical fields components (e.g., seismic, electric, magnetic, gravity, acoustic, temperature) and/or signals (e.g., optical, electromagnetic, elastic, radio waves) of the examined medium 3 measured by at least one sensor 2, and may be recorded by the processor 6 in the manner previously described.

The method 200 includes an act 220 of determining the sensitivity of the data acquisition system. For example, in one embodiment a sensitivity 25 of the data measured by at least one sensor 2 located at the proximity of the examined medium may be calculated in the manner previously described.

The method 200 includes an act 230 of selecting a priori integrated sensitivity having a maximum values within desired parts of the examined medium. For example, in one embodiment the approximate area of the location of the target zone 5 within the examined medium 3 can be identified, and the a priori integrated sensitivity 35 having maximum values within the target area can be calculated in the manner previously described.

The method 200 further includes an act 240 of determining parameters of an optimal transformation of the original data acquisition system into a new data acquisition system. For example, the processor may determine the parameters of the optimal transformation 45 of the original data acquisition system 1 into a new one 60 with the (controlled) integrated sensitivity by solving a minimization problem for a least square difference between the preselected and controlled sensitivities in the manner previously described.

The method 200 further includes an act 250 of constructing a new data acquisition system with focusing controlled sensitivity. For example, the processor 6 may also apply the optimal transformation 45 to the sensors 2 of the original data acquisition system in order to construct a new data acquisition system 60 with focusing controlled sensitivity.

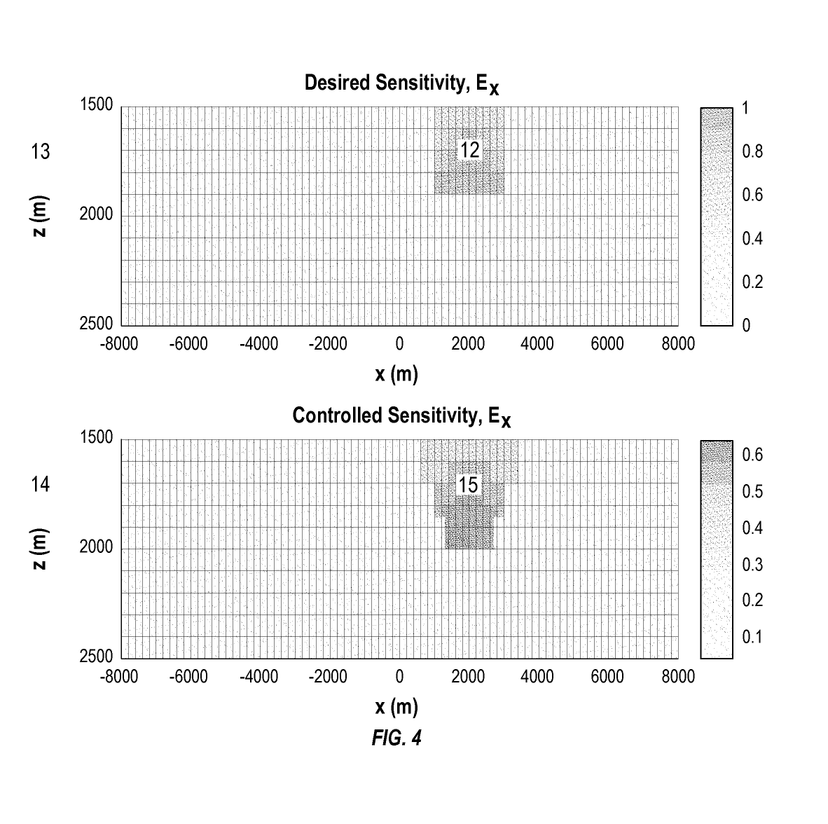

Attention is now turned to FIG. 5, which illustrates an alternative embodiment of the data acquisition system 1. In the embodiment of FIG. 5, the data acquisition system may be a portal 500 that includes one or more of the sensors 2. In some embodiments, the portal 500 may be a physical portal such as an airport screening device. As illustrated, the portal 500 is configured so that an object 510 may move through the portal 500 while being screened. The object 510 may be a body, an attached object, a container, or any other object that may move through the portal 500. In some embodiments, the object 510 is weapon.

As illustrated in FIG. 5, the portal 500 is coupled to the processor 6. The processor 6 is able to perform the operation of method 200 previously described. When performing such operation in relation to the portal 500, the processor 6 may perform one or more additional acts. For example, the method may further include the act of configuring the portal to accommodate and pass through the object 510. The sensor 2 may also record at least one component of the physical fields and/or signals generated in response to the object 510 moving through the portal 500.

In addition, the processor 6 is able to determine characteristics about the object 510. For example, in some embodiments the determined characteristic may be a material composition, the presence of an explosive material, the presence of a dangerous chemical substance, and/or the presence of a dangerous biological substance.

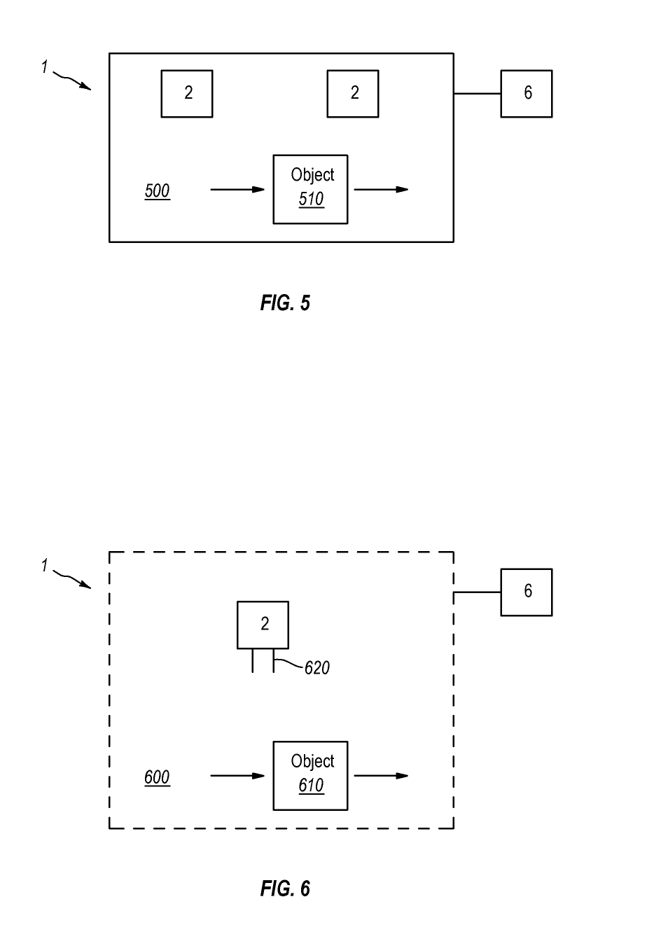

Attention is now given to FIG. 6, which illustrates a further alternative embodiment of the data acquisition system 1. In the embodiment of FIG. 6, the data acquisition system 1 includes a sensor 2 that is held on a post 620. It will be appreciated that the post 620 may be any holder able to support the sensor 2. The post 620 may stand on the floor or ground, or it may be located just under the floor or ground. The post 620 may also be located in the ceiling of a building. The sensor 2 and post 620 may then generate a virtual portal 600 for screening an object 810. In the FIG. 6, the dashed lines illustrate the virtual portal 600. As illustrated, the virtual portal 600 is configured so that the object 610 may move through the virtual portal 600 while being screened. The object 610 may be a body, an attached object, a container, or any other object that may move through the portal 600. In some embodiments, the object 610 is weapon.

As illustrated in FIG. 6, the virtual portal 600 is coupled to the processor 6. The processor 6 is able to perform the operation of method 200 previously described. When performing such operation in relation to the virtual portal 600, the processor 6 may perform one or more additional acts. For example, the method may further include the act of configuring the shape of the virtual portal 600 to accommodate and pass through the object 610. The sensor 2 may also record at least one component of the physical fields and/or signals generated in response to the object 610 moving through the virtual portal 600.

### Example 1

The following is an example of at least some of the principles of constructing data acquisition systems with focusing controlled sensitivity that is offered to assist in the practice of the disclosed embodiments. It is not intended thereby to limit the scope of the disclosure to any particular theory of operation or to any field of application. Consider a model, where the observed data d are related to the parameters of the examined medium m by a discrete operator equation:

d=A(m), (1)

where d=(d₁, d₂, d₃, . . . d_{N}_{_{d}}) is a vector of the observed EM data, m=(m₁, m₂, m₃, . . . m_{N}_{ₘ}) is a vector formed by the parameters of the examined medium in the model, and A is a forward modeling operator, which relates the model parameters to the observed data.
Applying the variational operator to both sides of equation (1), we obtain:

δd=Fδm, (2)

where F is the sensitivity (Fréchet derivative) matrix of the forward modeling operator A. The technique of determining sensitivity matrix F is discussed in Zhdanov (2002). The components of the sensitivity matrix F for a given data acquisition system are determined as a ratio of the perturbation of the observed data to the corresponding perturbation of the parameters of the examined medium.
The integrated sensitivity of the data to parameter δmₖ is determined as the ratio of the norm of perturbation of the observed data, δd, to the corresponding perturbation of the parameters of the examined medium (Zhdanov, 2002):

$${S}_{k} = \frac{‖ δ d ‖}{δ {m}_{k}} = \sqrt{{\sum }_{i} ( {F}_{ik} {F}_{ik}^{*} )} . \qquad ( 3 )$$

The diagonal matrix with diagonal elements equal to

$${S}_{k} = \frac{‖ δ d ‖}{δ {m}_{k}}$$

is called an integrated sensitivity matrix:

$$S = diag ( \sqrt{{\sum }_{i} ( {F}_{ik} {F}_{ik}^{*} )} ) = {diag ( {F}^{*} F )}^{1 / 2} . \qquad ( 4 )$$

We can consider a transformation of the original data acquisition system into a new data acquisition system by applying a linear operator to the data recorded by the original data acquisition system:

d_{c}=W_{c}d (5)

where W_{c} is the rectangular matrix, describing the parameters of this transformation. The integrated sensitivity matrix of the new data acquisition system to the parameter δm is determined according to the following formula:

$${S}_{c} = {diag ( {F}^{*} {W}_{c}^{*} {W}_{c} F )}^{\frac{1}{2}} . \qquad ( 6 )$$

One goal of at least one embodiment of the present invention is to create a data acquisition system with controlled sensitivity to the target located within a specific area of interest. For example, it is shown in FIG. 1A that the integrated sensitivity 4 rapidly decreases with the depth. A preferred embodiment of the present invention discloses the method of designing the parameters of the transformation W_{c}, which would increase the sensitivity of the survey to the specific target area 5, as shown in FIG. 1A.

We may select a priori integrated sensitivity matrix P having maximum values within the desirable part 5 (target area T) of the examined medium 3, as it is shown in FIG. 1A. In one embodiment of the present invention a priori preselected integrated sensitivity matrix P can be defined as a diagonal matrix [Pₖₖ], where index k corresponds to the parameter mₖ of the medium. The diagonal components Pₖₖ of matrix P are selected in such a way that they have large values, P_{large} for the parameter mₖ corresponding to the target area T, and small values Pₛₘₐₗₗ elsewhere:

Pₖₖ=P_{large}, if mₖ is within T; Pₖₖ=Pₛₘₐₗₗ, if mₖ is outside T. (7)

In order to create a data acquisition system with the controlled sensitivity to the target located within a specific area of interest, we require that parameters of the transformation, W_{c}, would satisfy the following condition:

diag(F*W_{c}*W_{c}F)≈P², (8)

where we define the dimensions of all corresponding matrices as follows:

P=[Nₘ×Nₘ], F=[N_{d}×Nₘ], W_{c}=[N_{w}×N_{d}]. (9)

We introduce the following notations for [N_{d}×N_{d}] matrix W_{c}*W_{c}:

Q=W_{c}*W_{c}, Q=[N_{d}×N_{d}]. (10)

We will call matrix Q a data acquisition system kernel matrix. Note that the kernel matrix Q is a Hermitian matrix: Q=Q*.

The data acquisition system kernel matrix Q may be found by solving a minimization problem for a least square difference between the a priori preselected and controlled sensitivities:

φ(Q)=Spur[(F*QF−P²)*(F*QF−P²)]=min, (11)

where symbol Spur denotes a trace of the corresponding matrix. Minimization problem (11) is solved using the corresponding methods of the regularized inverse theory (e.g., Zhdanov, 2002). After matrix Q is determined, we can find the parameters of the transformation, W_{c} solving another minimization problem:

ψ(Q)=∥(Q−W_{c}*W_{c})*(Q−W_{c}*W_{c})∥_{f}=min. (12)

Where ∥ . . . ∥_{f} denotes Frobenius norm of the matrix.

In one embodiment of the present invention we can substitute expression (10) for matrix Q in equation (11),

φ(Q)=φ(W_{c}*W_{c})=Spur[(F*W_{c}*W_{c}F−P²)*(F*W_{c}*W_{c}F−P²)]=min, (13)

and determine the parameters of the transformation, W_{c} directly by solving minimization problem (13).

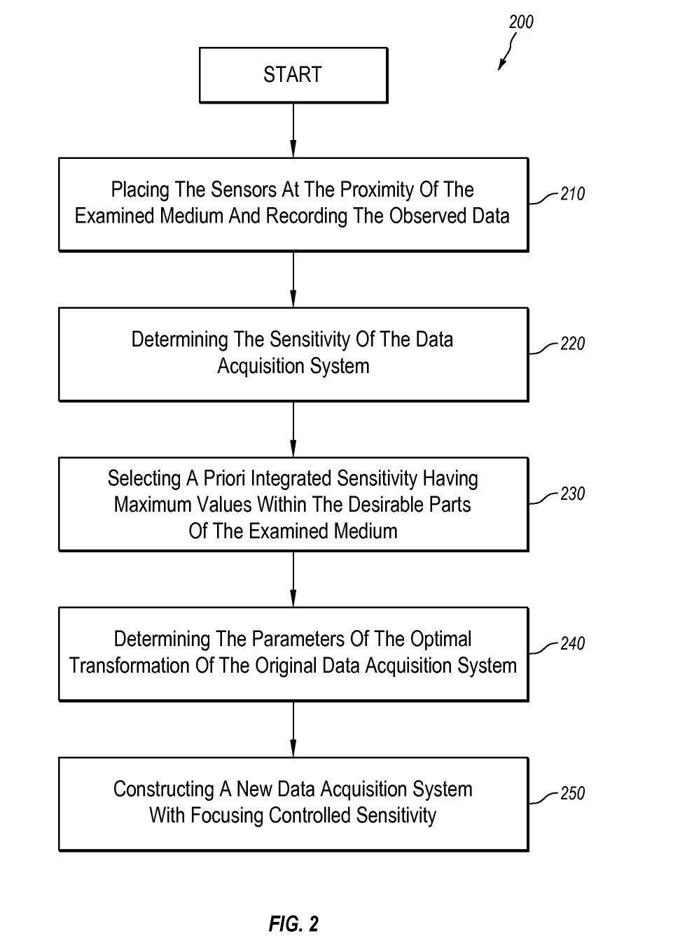

Referring to FIG. 2, in one embodiment, the operation of data acquisition system 1 can be summarily formulated as follows. The observed data, generated by the natural or artificial (controlled) sources, may be recorded by at least one sensor (or by plurality of sensors) 2, placed at some proximity of the examined medium 3, as indicated in FIG. 3. The processor may analyze the recorded data and may perform at least one of the following numerical processes:

(1) Numerically calculating the sensitivity of the data measured by at least one sensor located at the proximity of the examined medium, determined by formulae (3) and (4).

(2) Numerically calculating the a priori integrated sensitivity having maximum values within the given target area of the examined medium, according to formula (7).

(3) Determining the data acquisition system kernel matrix Q by solving a minimization problem for a least square difference between the a priori preselected and controlled sensitivities described by equation (11).

(4) Determine the parameters of the optimal transformation, W_{c}, of the original data acquisition system into a new one with the (controlled) integrated sensitivity by solving a minimization problem described by equation (12).

(5) Constructing a new data acquisition system with focusing controlled sensitivity by, for example, applying a linear operator (5) to the data recorded by the original data acquisition system, where the matrix W_{c} of the linear operator is a rectangular matrix, formed by the parameters of the optimal transformation defined by the numerical process (4), described above.

### Example 2

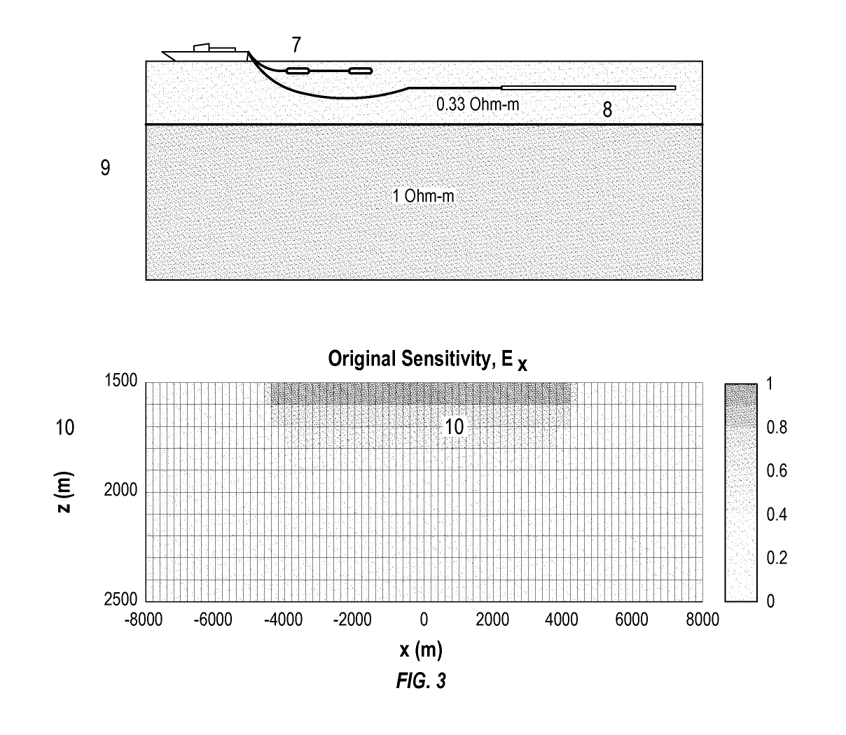

The following is an example of constructing a new data acquisition system with focusing controlled sensitivity for a model shown in FIG. 3, top panel. The present embodiment includes a model of a towed streamer marine electromagnetic survey conducted over a geoelectrical cross-section formed by a seawater layer with a thickness of 500 m, a resistivity of 0.33 Ohm-m, and a background layer of conductive sea-bottom sediments with a resistivity of 1 Ohm-m. The domain for the sensitivity study, 10, extends from 1500 m to 2500 m in depth, and we select the target area 12 (FIG. 4), where we want to have an increased sensitivity of a new transformed data acquisition system.

In the present embodiment, the electric field data may be generated by an electric dipole transmitter 7 moving in the x direction along a horizontal line at a depth of 10 m below the sea surface, and it may be measured by at least one sensor 8 of electric field, towed at some offset behind the transmitter at a depth of 100 m below the sea surface, shown in FIG. 3. The transmitter may generate a frequency domain EM field with a frequency of 0.1 Hz from points located every 100 m along the survey line. The location of the profiles and the frequencies may vary. Other combinations of locations and frequencies may be used. A time-domain signal may be used. The receivers may measure electric and or/magnetic fields, or combinations thereof.

FIG. 3 illustrates the behavior of the integrated sensitivity 10 of the data acquisition system for a model 9 shown in FIG. 3. As one would expect, the sensitivity of the original data acquisition system rapidly decreases with the depth. According to formula (7), we may select the a priori sensitivity having maximum values within the given target area 12 of the examined medium (see FIG. 4); this preselected (desired) a priori sensitivity is shown in FIG. 4. We set the maximum values of the a priori sensitivity within the target area 12 ranging from 1500 m to 1900 m and from 1000 m to 3000 m in the vertical and horizontal directions, respectively, as shown in FIG. 4.

In the present embodiment, the processor 6 can be applied to determine the parameters of the optimal transformation of the original data acquisition system into a new one with the (controlled) integrated sensitivity by solving a minimization problem (11) for a least square difference between the preselected and controlled sensitivities. The corresponding controlled sensitivity (14) is shown in FIG. 4. This controlled sensitivity has the maximum within the targeted interval 15, as it is required by the method of the present invention.

The parameters of the optimal transformation, W_{c}, of the original data acquisition system into a new one with the (controlled) integrated sensitivity are then determined by the processor 5 by solving a minimization problem described by equation (12).

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical non-transitory storage media. Computer-readable media that carry computer-executable instructions are transmission media. Thus, by way of example, and not limitation, embodiments of the invention can comprise at least two distinctly different kinds of computer-readable media: physical non-transitory storage media and transmission media.

Physical non-transitory storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for constructing data acquisition systems with focusing controlled sensitivity, which have maximum values in zones of interest within a medium under investigation, the method comprising:
a. placing at least one sensor of corresponding physical fields and/or signals, generated by natural or artificial (controlled) sources, at some proximity to the examined medium;
b. measuring at least one component of the corresponding physical fields and/or signals with the at least one sensor and recording the observed data by a corresponding recording device;
c. determining the sensitivity of the data acquisition system as a ratio of a perturbation of the measured data to a corresponding perturbation of parameters of the examined medium;
d. selecting an a priori integrated sensitivity, having maximum values within the zones of interest of the examined medium;
e. determining parameters of an optimal transformation of the original data acquisition system into a new data acquisition having a (controlled) integrated sensitivity closely duplicating the preselected a priori sensitivity by solving a minimization problem for a least square difference between the preselected and controlled integrated sensitivities;
f. applying the optimal transformation to the sensors of the original data acquisition system in order to construct a new data acquisition system with focusing controlled sensitivity.

2. The method of claim 1, wherein the at least one sensor comprises a plurality of sensors arranged in an array on the surface or within the examined medium.

3. The method of claim 2, wherein the plurality of sensors include seismic, electric, magnetic, gravity, acoustic, and/or temperature field sensors.

4. The method of claim 2, wherein the plurality of sensors include optical, electromagnetic, elastic, and/or radio wave signal sensors.

5. The method of claim 1, wherein the measured data are input to a processor, and the processor includes executable instructions to:
a. numerically calculate the sensitivity of the data measured by at least one sensor located at the proximity of the examined medium;
b. numerically calculate the a priori integrated sensitivity having maximum values within the zones of interest of the examined medium;
c. determine the parameters of the optimal transformation of the original data acquisition system into the new data acquisition system with the (controlled) integrated sensitivity by solving the minimization problem for a least square difference between the a priori preselected and controlled sensitivities;
d. construct the new data acquisition system with focusing controlled sensitivity by applying to the data recorded by the original data acquisition system the optimal transformation.

6. The method of claim 1, wherein the data acquisition system comprises a portal that includes the at least one sensor of at least one physical field and/or signal, and may be used for security screening a body and/or attached object, or a container, or another object which is moving through the portal, the method further comprising:
a. configuring the portal to accommodate and pass there through a body and/or an attached object, or a container, or another object.
b. recording with the at least one sensor at least one component of the corresponding physical fields and/or signals, generated as a response from a body and/or attached object, or a container, or another object which is moving through the portal.
c. determining the sensitivity of the data acquisition system to the parameters of the object moving through the portal, as a ratio of the perturbation of the observed data to the corresponding perturbation of the parameters of the examined object;
d. selecting a priori integrated sensitivity, having maximum values within the portal, and minimum sensitivity outside the portal; determining the parameters of the optimal transformation of the original data acquisition system into a new one with the (controlled) integrated sensitivity closely duplicated the preselected sensitivity by solving a minimization problem for a least square difference between the preselected and controlled sensitivities;
e. applying this optimal transformation to the sensors of the original data acquisition system in order to constructing a new data acquisition system with focusing controlled sensitivity within the portal.

7. The method of claim 1, wherein the data acquisition system comprises at least one sensor located in at least one post, standing on the floor or on the ground, or in the holder located just under the floor or under the ground surface, the system being for creating a virtual portal for security screening a body and/or attached object, or a container, or another object which is moving through the virtual portal, the method further comprising:
a. configuring the geometrical shape of desired virtual portal to accommodate and pass there through the body and/or an attached object, or a container, or another object.
b. recording with the at least one sensor at least one component of the corresponding physical fields and/or signals, generated as a response from a body and/or attached object, or a container, or another object which is moving through the virtual portal.
c. determining the sensitivity of the data acquisition system to the parameters of the object moving through the virtual portal, as a ratio of the perturbation of the observed data to the corresponding perturbation of the parameters of the examined object;
d. selecting a priori integrated sensitivity, having maximum values within the virtual portal, and minimum sensitivity outside the virtual portal; determining the parameters of the optimal transformation of the original data acquisition system into a new one with the (controlled) integrated sensitivity closely duplicated the preselected sensitivity by solving a minimization problem for a least square difference between the preselected and controlled sensitivities;
e. applying this optimal transformation to the sensors of the original data acquisition system in order to constructing a new data acquisition system with focusing controlled sensitivity within the virtual portal.

8. The method of claims 6 and 7, wherein the attached object is a weapon.

9. The method of claims 6 and 7, wherein the determined characteristic of the attached object or a container, or another object, which is moving through the portal or virtual portal is material composition.

10. The method of claims 6 and 7, wherein the determined characteristic of the attached object or a container, or another object, which is moving through the portal or virtual portal is the presence of explosive material.

11. The method of claims 6 and 7, wherein the determined characteristic of the attached object or a container, or another object, which is moving through the portal or virtual portal is the presence of a dangerous chemical substance.

12. The method of claims 6 and 7, wherein the determined characteristic of the attached object or a container, or another object, which is moving through the portal or virtual portal is the presence of a dangerous biological substance.

13. A physical non-transitory computer readable medium having stored thereon computer executable instructions that when executed by a processor cause a computing system to perform a method of constructing data acquisition systems with focusing controlled sensitivity, which have maximum values in zones of interest within a medium under investigation, the method comprising:
a. measuring at least one component of the corresponding physical fields and/or signals with the at least one sensor and recording the observed data by a corresponding recording device;
b. determining the sensitivity of the data acquisition system as a ratio of a perturbation of the measured data to a corresponding perturbation of the parameters of the examined medium;
c. selecting an a priori integrated sensitivity having maximum values within the zones of interest of the examined medium;
d. determining parameters of an optimal transformation of the original data acquisition system into a new data acquisition system with (controlled) integrated sensitivity closely duplicating the preselected a priori sensitivity by solving a minimization problem for a least square difference between the preselected and controlled sensitivities; and
e. applying the optimal transformation to the sensors of the original data acquisition system in order to construct a new data acquisition system with focusing controlled sensitivity.

14. A system for constructing data acquisition systems with focusing controlled sensitivity, which has maximum values in the zones of interest within a medium under investigation comprising:
at least one sensor corresponding to physical fields and/or signals generated by natural or artificial (controlled) sources; and
a computing system, the computing system comprising:
a processor; and
one or more physical non-transitory computer readable medium having computer executable instructions stored thereon that when executed by the processor, cause the computing system to perform the following:
a. measure at least one component of corresponding physical fields and/or signals with the at least one sensor and record the observed data by a corresponding recording device;
b. determine the sensitivity of the data acquisition system as a ratio of a perturbation of the measured data to a corresponding perturbation of parameters of the examined medium;
c. select an a priori integrated sensitivity having maximum values within the zones of interest of the examined medium;
d. determine parameters of an optimal transformation of the original data acquisition system into a new data acquisition system with (controlled) integrated sensitivity closely duplicating the preselected a priori sensitivity by solving a minimization problem for a least square difference between the preselected and controlled sensitivities; and
e. apply the optimal transformation to the sensors of the original data acquisition system in order to construct a new data acquisition system with focusing controlled sensitivity.

15. The system of claim 14, wherein the at least one sensor comprises a plurality of sensors arranged in an array on the surface or within the examined medium.

16. The system of claim 14, wherein the plurality of sensors include seismic, electric, magnetic, gravity, acoustic, and/or temperature field sensors.

17. The system of claim 14, wherein the plurality of sensors include optical, electromagnetic, elastic, and/or radio wave signal sensors.
